(19) United States
(12) Patent Application Publication
(10) Pub. No.: US 2008/0238329 A1
(43) Pub. Date: Oct. 2, 2008

(54) Plasma display device and driving method thereof

(76) Inventors: Sang-Min Nam, Suwon-si (KR); Jung-Pil Park, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/005,702

(22) Filed: Dec. 27, 2007

(30) Foreign Application Priority Data
Mar. 27, 2007 (KR) 10-2007-0029772

(51) Int. Cl. G09G 3/10; G09G 3/26; G06F 3/038

(52) U.S. Cl. 315/169.4; 345/67; 345/211

(57) ABSTRACT

A plasma display device and driving method thereof are disclosed. In the plasma display device, a wall charge state of each cell is initialized after forming a wall voltage between respective sustain electrodes by gradually decreasing a voltage of the sustain electrodes. In addition, in a sustain period, a high level sustain discharge pulse having a positive voltage and a low level sustain discharge pulse having a negative voltage are applied to the sustain electrode while maintaining a voltage of a scan electrode at a ground voltage. In this way, a maximum voltage applied to a scan electrode driver that applies the driving waveform to the scan electrode is decreased. In addition, a sustain discharge pulse is applied only to the sustain electrode, which is a common electrode, and therefore the driving waveform between each cell can be prevented from being distorted in the sustain period.

### CROSS-REFERENCE TO RELATED APPLICATION

This application claims priority to and the benefit of Korean Patent Application No. 10-2007-0029772 filed in the Korean Intellectual Property Office on Mar. 27, 2007, the entire contents of which are incorporated herein by reference.

### BACKGROUND

1. Field

The field relates to a plasma display device and a driving method thereof.

2. Description of the Related Technology

A plasma display device is a flat panel display that uses plasma generated by a gas discharge to display characters or images. It includes a plasma display panel (PDP) wherein tens to millions of discharge cells are arranged in a matrix format, depending on its size.

Generally, in a plasma display device, one frame is divided into respectively weighted subfields. A luminance of a discharge cell is determined by a sum of weights of subfields at which the corresponding discharge cell is turned on among the plurality of subfields.

Each subfield includes a reset period, an address period, and a sustain period. The reset period is for initializing the status of each discharge cell, and the address period is for performing an addressing operation so as to select light emitting cells. The sustain period is for displaying an image by sustain-discharging the light emitting cells selected in the address period for a period that corresponds to a weight of the corresponding subfield.

Generally, during the reset period, a reset falling waveform that gradually decreases is applied to a scan electrode after applying a reset rising waveform that gradually increases to a scan electrode so as to reset the wall charge state of all discharge cells. In this case, the highest voltage level of the reset rising waveform is set to be two times greater than a high level voltage of a sustain discharge pulse that is alternately applied to the scan electrode and a sustain electrode. Accordingly, in a scan electrode driver that applies a driving voltage to the scan electrode, a plurality of elements associated with generation of the reset rising waveform must tolerate a relatively high voltage.

In addition, a sustain pulse is alternately applied to the scan electrode and the sustain electrode so as to generate a sustain discharge during a sustain period. However, since the scan electrode and the sustain electrode act as a capacitor, a capacitance component formed by the scan electrode and the sustain electrode exist. The capacitance component will be referred to as a panel capacitor. Therefore, a reactive power is required for applying a sustain discharge pulse during the sustain period. A circuit that recovers and reuses reactive power is called a power recovery circuit. That is, a scan electrode driver that applies a driving voltage to a scan electrode and a sustain electrode driver that applies a driving voltage to a sustain electrode are respectively connected with separate power recovery circuits in order to apply the sustain discharge pulse. Accordingly, a driving device of the plasma display device becomes complicated.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE EMBODIMENTS

One aspect is a plasma display device including a plasma display panel (PDP) having a plurality of first electrodes and a plurality of second electrodes, a first driver connected to the plurality of first electrodes and configured to apply a first voltage to the plurality of first electrodes during a sustain period, and a second driver connected to the plurality of second electrodes and configured to apply a sustain discharge pulse to the plurality of second electrodes during the sustain period, the sustain discharge pulse alternately having a second voltage that is greater than the first voltage and a third voltage that is less than the first voltage. The first driver includes a first switch having a first end connected to a first power source that supplies the first voltage, a second end connected to the plurality of first electrodes, and a body diode having a cathode connected to the first end of the first switch and an anode connected to the second end of the first switch, and a second switch having a first end connected to a second power source that supplies a fourth voltage that is less than the first voltage, a second end connected to the plurality of first electrodes, and a body diode having an anode connected to the first end of the second switch and a cathode connected to the second end of the second switch, where the second end of the first switch and the second end of the second switch are connected to each other.

Another aspect is a driving method of a plasma display device having a plurality of first electrodes and a plurality of second electrodes. The driving method includes during a sustain period, maintaining the voltage of the first electrodes at a first voltage by turning on a first switch connected between a first power source that supplies the first voltage and the plurality of first electrodes, and alternately applying a sustain discharge pulse to the plurality of second electrodes, the sustain discharge pulse having a second voltage and a third voltage, the second voltage being greater than a first voltage and the third voltage being less than the first voltage, during a reset period, gradually decreasing a voltage of the plurality of second electrodes to the second voltage while maintaining the voltage of the plurality of first electrodes at a fourth voltage, the fourth voltage being greater than the first voltage, and gradually decreasing the voltage of the plurality of first electrodes to a sixth voltage, the sixth voltage being less than the first voltage, and maintaining a voltage of the plurality of second electrodes at a fifth voltage, the fifth voltage greater than the first voltage, and during an address period, sequentially applying a seventh voltage to the plurality of first electrodes by turning on a second switch connected between a second power source that supplies the seventh voltage, the seventh voltage being less than the first voltage.

### BRIEF DESCRIPTION OF THE DRAWINGS

FIG. 1 is a schematic view of a plasma display device.

FIG. 2 shows a driving waveform of the plasma display device.

FIG. 3 shows a circuit of a scan electrode driver and a sustain electrode driver.

FIG. 4A and FIG. 4B show current flows of a scan electrode driver and a sustain electrode driver of FIG. 3 in a reset period.

FIG. 5 shows driving timing of the sustain electrode driver of FIG. 3 in a sustain period.

FIG. 6A and FIG. 6B show current flows of the sustain electrode driver of FIG. 3 in the sustain period.

FIG. 7 shows a circuit of a sustain electrode driver.

FIG. 8 shows driving timing of the sustain electrode driver of FIG. 7 in a sustain.

FIG. 9A and FIG. 9B show current flows the sustain electrode driver of FIG. 7 in the sustain period.

FIG. 10 shows a scan electrode driver and a sustain electrode driver.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be directly coupled to the other element, indirectly coupled to the other element, and/or electrically coupled to the other element through a third element. In addition, unless explicitly described to the contrary, the word “comprise” and variations such as “comprises” or “comprising” will be understood to imply the inclusion of stated elements but not the exclusion of any other elements.

Wall charges mentioned in the following description mean charges formed and accumulated on a wall (e.g., a dielectric layer) close to an electrode of a discharge cell. A wall charge will be described as being “formed” or “accumulated” on the electrodes, although the wall charges do not actually touch the electrodes.

Further, a wall voltage means a potential difference formed on the wall of the discharge cell by the wall charge.

A plasma display device and a driving method thereof according to one embodiment will be described in further detail with reference to the accompanying drawings.

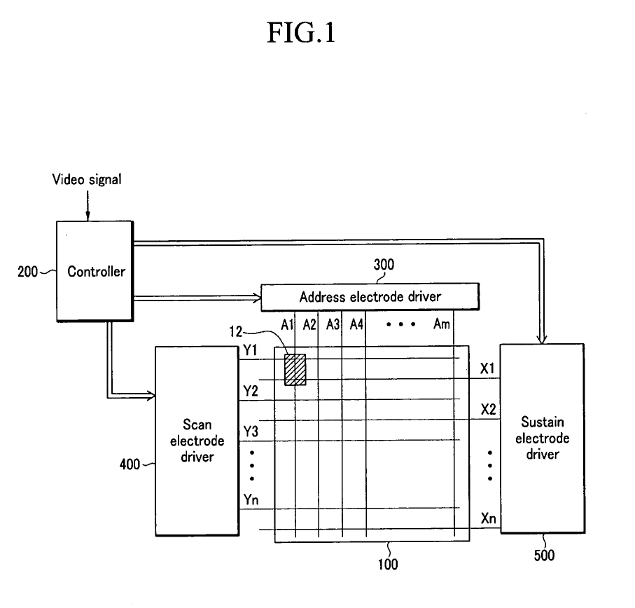

FIG. 1 is a schematic view of a plasma display according to on embodiment.

As shown in FIG. 1, the plasma display includes a plasma display panel (PDP) 100, a controller 200, an address electrode driver 300, a scan electrode driver 400, and a sustain electrode driver 500. The PDP 100 includes a plurality of address electrodes A1 to Am extending in a column direction, and a plurality of sustain and scan electrodes X1 to Xn and Y1 to Yn extending in a row direction. Hereinafter, the address electrode, the sustain electrode, and the scan electrode will be respectively referred to as an A electrode, an X electrode, and a Y electrode. The plurality of Y electrodes Y1 to Yn and the plurality of X electrodes X1 to Xn are arranged as pairs. A discharge cell 12 is formed at a crossing region of the A electrodes A1 to Am with the X and Y electrodes X1 to Xn and Y1 to Yn.

The controller 200 externally receives video signals and outputs an address electrode driving control signal, a sustain electrode driving control signal, and a scan electrode driving control signal. In addition, the controller 200 controls the plasma display by dividing one frame into a plurality of subfields, each having a weight.

The address electrode driver 300 receives an address electrode driving control signal from the controller 200, and applies a signal to the respective A electrodes for selecting discharge cells to be displayed. The scan electrode driver 400 receives a scan electrode driving control signal from the controller 200 and applies a driving voltage to the Y electrodes Y1 to Yn, and the sustain electrode driver 500 receives a sustain electrode driving control signal from the controller 200 and applies a driving voltage to the X electrodes X1 to Xn.

A driving waveform of the plasma display device will now be described. In the following description, a driving waveform applied to a Y electrode, an X electrode, and an A electrode that form one cell will be described for convenience of description.

According to the embodiment, one frame is divided into a plurality of subfields, each having a weight, where each subfield includes a reset period, an address period, and a sustain period. A reset period included in at least one subfield among the plurality of subfields is set to a main reset period for initializing all discharge cells. The main reset period includes a first reset period and a second reset period. In addition, other reset periods that are not included in the main reset period are included in the auxiliary reset periods for initializing wall charges in cells that have experienced a sustain discharge during a reset period of a previous subfield.

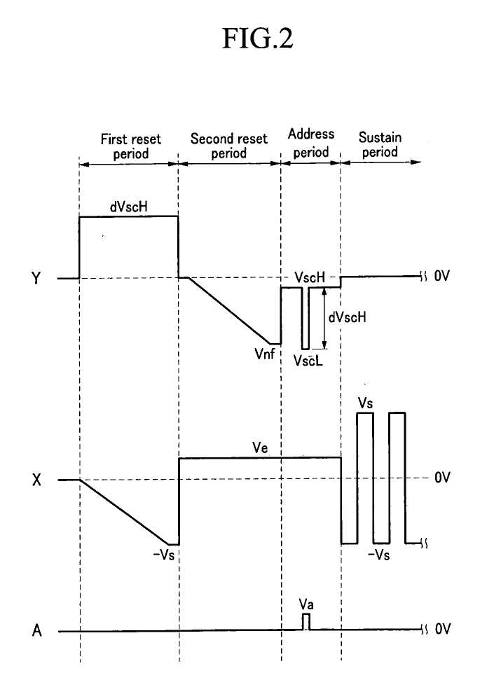

FIG. 2 shows a driving waveform of the plasma display device. A subfield in FIG. 2 is included in a plurality of subfields divided from one frame and set to a main reset period.

As shown in FIG. 2, in a first reset period, a voltage of an X electrode is gradually decreased to a low sustain voltage (−Vs voltage in FIG. 2) from 0V, while a reset start voltage (i.e., dVscH voltage in FIG. 2) and a reference voltage (0V in FIG. 2) are respectively applied to a Y electrode and an A electrode. As described, while the voltage of the X is gradually decreased, a voltage difference between the X electrode and the Y electrode and a voltage difference between the X electrode and the A electrode are increased so that a weak discharge (hereinafter referred to as a reset discharge) is generated between the X electrode and the Y electrode, between the X electrode and A electrode, and between the Y electrode and the A electrode. Due to the reset discharge, positive (+) wall charges are formed on the X electrode and negative (−) wall charges are formed on the Y and A electrodes.

In a second reset period, a voltage of the Y electrode is gradually decreased from 0V to the lowest Y reset voltage (Vnf voltage in FIG. 2) while a bias voltage (Ve voltage in FIG. 2) and the 0V voltage are respective applied to the X electrode and the A electrode. While the voltage of the Y electrode is gradually decreased, a reset discharge is generated between the Y and X electrodes, between the Y and A electrodes, and between the X and A electrodes so that the positive (+) wall charges formed on the X electrode and the negative (−) wall charges formed on the A electrodes are erased. In general, a (Vnf−Ve) voltage substantially corresponds to a discharge firing voltage (Vfxy) between the Y electrode and the X electrode. Accordingly, a wall voltage between the Y and X electrodes becomes 0V when a second reset period is terminated, and therefore occurrence of misfiring or a low discharge in a sustain period can be prevented. In this case, the Vnf voltage may be set to greater than or equal to the −Vs voltage.

As shown in FIG. 2, in an address period, a scan voltage (VscL voltage in FIG. 2) is sequentially applied to the plurality of Y electrodes while the Ve voltage is applied to the X electrode for selecting discharge cells to be turned on. In this case, an address voltage (Va voltage in FIG. 2) is applied to an A electrode that passes a discharge cell to be selected from among a plurality of discharge cells to which the VscL voltage is applied. Then, an address discharge is generated between the A electrode applied with the Va voltage and the Y electrode applied with the VscL voltage and between the Y electrode applied with the VscL voltage and the Y electrode applied with the Ve voltage so that positive (+) wall charges are formed on the Y electrode and negative (−) wall charges are formed on the A and X electrodes. Herein, the VscL voltage may be set to be equal to or less than the Vnf voltage for reducing the number of power sources, and the Vnf voltage set to be greater than the VscL voltage can be generated through a power source that generates the VscL voltage and a Zener diode VscL having a breakdown voltage. In addition, a Y electrode to which the VscL voltage is not applied is applied with a non-scan voltage (VscH voltage in FIG. 2), and an A electrode forming a un-selected discharge cell is applied to the 0V voltage.

In a sustain period, a sustain discharge pulse of the −Vs voltage and a sustain discharge pulse of a high sustain voltage (Vs voltage in FIG. 2) are alternately applied to the X electrode while the 0V voltage is applied to the Y electrode and the A electrode so that a sustain discharge is generated in a discharge cell selected during the address period.

That is, since the positive (+) wall charges and the negative (−) wall charges are respectively formed on the Y electrode and the X and A electrodes of the discharge cell that has experienced the address discharge, the sustain discharge pulse of the −Vs voltage is applied to the X electrode so as to generate the first sustain discharge in the sustain period. After the first sustain discharge is generated, positive (+) wall charges are formed on the X electrode and negative (−) wall charges are formed on the Y electrode and the A electrode. Since wall charge distribution has been changed due to the first sustain discharge, a sustain discharge pulse of the Vs voltage is applied to the X electrode so as to generate the second sustain discharge. After the second sustain discharge is generated, negative (−) wall charges are formed on the X electrode and positive (+) wall charges are formed on the Y electrode and the A electrode.

The process of applying the sustain discharge pulse of the −Vs voltage to the X electrode and the process of applying the sustain discharge pulse of the Vs voltage are repeated a number of times corresponding to a weight of the corresponding subfield during the sustain period.

In addition, for convenience of description, a falling waveform applied to the X electrode and the Y electrode during the reset period is illustrated as a ramp waveform in FIG. 2. However, the waveform that gradually increases or decreases includes an RC waveform, a waveform that is floated while being gradually increased or gradually increased, or another waveform.

As described above, since the Y electrode is applied with a voltage that is less than the Vs voltage, the number of power sources connected to the scan electrode driver can be reduced and a maximum voltage applied to an element can be reduced, thereby achieving stable driving of the scan electrode driver. In addition, the sustain pulse is applied only to the X electrode, and therefore distortion of the driving waveform in the sustain period can be prevented.

A plasma display device that generates the driving waveform of FIG. 2 and having a simple-structured driving circuit will be described in further detail. In the following description, a switch is illustrated as an n-channel field effect transistor (FET) having a body diode (not show). The FET can be replaced with another element having the same or similar functions of the FET. In addition, a capacitance component formed by the X electrode and the Y electrode is illustrated as a panel capacitor Cp.

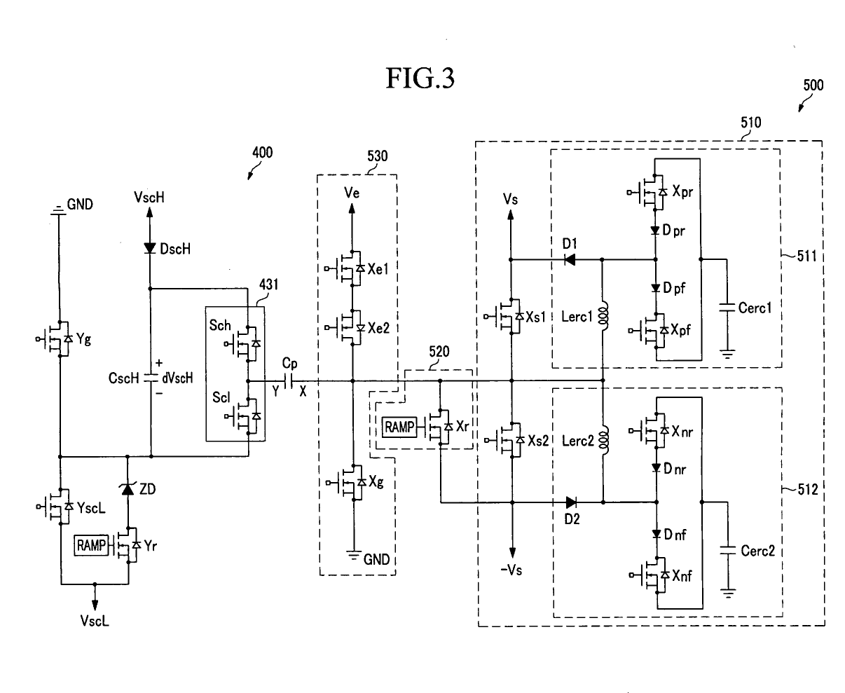

FIG. 3 shows a circuit of a scan electrode driver 400 and a sustain electrode driver 500 according to a first exemplary embodiment of the present invention.

As shown in FIG. 3, the scan electrode driver 400 includes switches Yg, YscL, and Yr, a capacitor CscH, a diode DscH, and a plurality of selection circuits. The scan electrode driver 400 applies a gradually-falling voltage waveform to the plurality of Y electrodes during the second reset period, sequentially applies a scan voltage to the plurality of Y electrodes during an address period, and applies 0V voltage to the plurality of Y electrodes during a sustain period.

The switch Yg has a first end coupled to the Y electrode and a second end coupled to a GND power source, and is turned on during the sustain period and applies the 0V voltage to the Y electrode. In addition, the switch YscL has a first end coupled to a VscL power source that supplies a VscL voltage and a second end coupled to the Y electrode. In the address period, when the switch YscL is turned on, a voltage at the second end of the switch YscL corresponds to the VscL voltage.

In addition, as shown in FIG. 3, in a connection between an n-channel FET switch Yg and an n-channel FET switch YscL, a source of the switch Yg and a drain of the switch YscL are connected to each other. The anode of the body diode of the switch Yg is connected with the Y electrode and the cathode of the body diode of the switch YscL is connected with the Y electrode. Accordingly, a current flowing to the GND power source can be prevented from being generated while a voltage that is less than the 0V voltage is applied to the Y electrode, and therefore there is no need to provide an additional switch between the GND power source and the YscL power source.

The switch Yr has a first end connected to the VscL power source and a second end connected to a Zener diode (ZD), and a cathode of the Zener diode ZD is connected to the Y electrode. In this case, positions of the Zener diode ZD and the switch Yr can be switched. That is, an anode of the Zener diode ZD may be connected to the YscL power source and the cathode may be connected to the first end of the switch Yr, and the second end of the switch Yr may be connected to the Y electrode. The switch Yr is turned on in the second reset period, and when the switch Yr is turned on, a cathode voltage of the Zener diode ZD is gradually decreased to the Vnf voltage that corresponds to a sum of the VscL voltage and a breakdown voltage of the Zener diode ZD.

The capacitor CscH has a first end connected to a VscH power source that supplies the VscH voltage and a second end connected to the second end of the switch YscL having the first end connected to the VscL power source. The capacitor CscH turns on the switch YscL at an initial driving stage of the plasma display device and is charged with a dVscH voltage that corresponds to a voltage difference (i.e., VscH−VscL) between the VscH voltage and the VscL voltage.

The diode DscH has an anode connected to a VscH power source and a cathode connected to the first end of the capacitor CscH. The diode DscH prevents a current flowing to the VscH power source when the panel capacitor Cp is applied with a voltage that is greater than the VscH voltage so that the voltage of the Y electrode can be stably sustained.

The selection circuit 431 includes a switch Sch and a switch Scl. The switch Sch has a first end connected to a node between the diode DscH and the capacitor CscH and a second end connected to the Y electrode. In addition, the switch Scl has a first end connected to the VscL power source and a second end connected to the Y electrode. Although FIG. 3 illustrates the selection circuit 431 connected to only one Y electrode, the plasma display device according to the exemplary embodiment of the present invention includes a plurality of selection circuits respectively connected to the plurality of Y electrodes, and each selection circuit is generally provided as an IC formed by connecting a plurality of selection circuits.

As shown in FIG. 3, the sustain electrode driver 500 includes a sustain driver 510, a reset driver 520, and a bias driver 530.

The sustain driver 510 includes a first power recovery unit 511, a second power recovery unit 512, and switches Xs1 and Xs2, and alternately applies the sustain discharge pulse of the Vs voltage and the sustain discharge pulse of the −Vs voltage to the X electrode during the sustain period. Herein, the first power recovery unit 511 is provided to recover reactive power when the voltage of the X electrode is fluctuated between the Vs voltage and the 0V voltage, and the second power recovery unit 512 is provided to recover the react power when the voltage of the X electrode is fluctuated between the −Vs voltage to the 0V voltage.

The switch Xs1 has a first end connected to a Vs power source that supplies the Vs voltage and a second end connected to the X electrode, and applies the Vs voltage to the X electrode when it is turned on in the sustain period. In addition, the switch Xs2 has a first end connected to a −Vs power source that supplies the −Vs voltage and a second end connected to the X electrode, and applies the −Vs voltage to the X electrode when it is turned on in the sustain period.

The first power recovery unit 511 includes switches Xpr and Xpf, diodes Dpr, Dpf, and D1, a capacitor Cerc1, and an inductor Lerc1. In this case, the capacitor Cerc1 is charged with a voltage (e.g., Vs/2 voltage) between the Vs voltage and the 0V voltage, and a first end of the inductor Lerc1 is connected to the X electrode.

The switch Xpr has a first end connected to a first end of the capacitor Cerc1 and a second end connected to an anode of the diode Dpr, and a cathode of the diode Dpr is connected to the first end of the inductor Lerc1. In addition, a second end of the inductor Lerc1 is connected to the X electrode. The switch Xpf has a first end connected to the first end of the capacitor Cerc1 and a second end connected to a cathode of the diode Dpf, and the anode of the diode Dpr is connected to the first end of the inductor Lerc1.

When the switch Xpr of the first power recovery unit 511 is turned on in the sustain period, an LC resonant current is generated between the capacitor Cerc1, the inductor Lerc1, and the panel capacitor Cp, and the voltage of the X electrode is increased close to the Vs voltage due to the resonant current. In addition, when the switch Xpf is turned on in the sustain period, an LC resonant current is generated between the panel capacitor Cp, the inductor Lerc1, and the capacitor Cerc1, and the voltage of the X electrode is decreased close to the 0V voltage due to the resonant current.

In addition, the diode D1 has a cathode connected to the Vs power source and an anode connected to the first end of the inductor Lerc1. When an electromotive force that is greater than the Vs voltage is generated at the first end of the inductor Lerc1 due to the resonant current that is generated when the switch Xpr or the switch Xpf is turned on, the voltage at the first end of the inductor Lerc1 can be maintained at the Vs voltage by the diode D1. Accordingly, a maximum voltage of a peripheral element can be reduced.

In the first power recovery unit 511, positions of the switch Xpr and the diode Dpr can be switched, and positions of the switch Xpf and the diode Dpf also can be switched. That is, the cathode of the diode Dpr may be connected to the first end of the switch Xpr and the first end of the inductor Lerc1 may be connected to the second end of the switch Xpr. In addition, the anode of the diode Dpf may be connected to the first end of the switch Xpf and the first end of the inductor Lerc1 may be connected to the second end of the switch Xpf.

The second power recovery unit 512 includes switches Xnr and Xnf, diodes Dnr, Dnf, and D2, a capacitor Cerc2, and an inductor Lerc2. In this case, the capacitor Cerc2 is charged with a voltage (e.g., −Vs/2 voltage) between the 0V voltage and the −Vs voltage, and the first end of the inductor Lerc2 is connected to the X electrode.

The switch Xnr has a first end connected to a first end of the capacitor Cerc2 and a second end connected to an anode of the diode Dnr, and a cathode of the diode Dnr is connected to a first end of the inductor Lerc2. In addition, a second end of the inductor Lerc2 is connected to the X electrode. The switch Xnf has a first end connected to the first end of the capacitor Cerc2 and a second end connected to a cathode of the diode Dnf, and an anode of the diode Dnf is connected to the first end of the inductor Lerc2.

In the second power recovery unit 512, when the switch Xnr is turned on in the sustain period, an LC resonant current is generated between the capacitor Cerc2, the inductor Lerc2, and the panel capacitor Cp, and the voltage of the X electrode is increased close to the 0V voltage due to the resonant current. When the switch Xnf is turned on in the sustain period, an LC resonant current is generated between the panel capacitor Cp, the inductor Lerc2, and the capacitor Cerc2, and the voltage of the X electrode is decreased close to the −Vs voltage due to the resonant current.

As in the first power recovery unit 511, positions of the switch Xnr and the diode Dnr can be switched with each other and positions of the switch Xnf and the diode Dnf also can be switched with each other in the second power recovery unit 512.

In addition, an anode of the diode D2 is connected to the −Vs power source and a cathode of the diode D2 is connected to the first end of the inductor Lerc2. When an electromotive force that is less than the −Vs voltage is generated at the first end of the inductor Lerc2 due to the resonant current that is generated when the switch Xnr or the switch Xnf is turned on, the voltage at the first end of the inductor Lerc2 can be maintained at the −Vs voltage by the diode D2. Accordingly, the maximum voltage applied to a peripheral element is reduced.

The reset driver 520 includes a switch Xr connected between the −Vs power source and the X electrode. When the switch Xr is turned on in the first reset period of the reset period, the voltage of the X electrode is gradually decreased to the −Vs voltage. That is, a first end of the switch Xr is connected to the −Vs power source and a second end of the switch Xr is connected to the X electrode. Therefore, when the switch Xr is turned on in the first reset period, the voltage of the X electrode is gradually decreased to the −Vs voltage.

In addition, the bias driver 530 includes switches Xe1 and Xe2 connected between the Ve power source that supplies the Ve voltage and the X electrode.

The switch Xe1 and the switch Xe2 can be provided as n-channel FETs, each having a body diode, and therefore a voltage charged in the panel capacitor Cp can be applied to the Ve power source through the body diodes. Therefore, the Ve power source can be prevented from being overcharged by back-to-back connecting the switch Xe1 and the switch Xe2. That is, as shown in FIG. 3, a source of the FET formed of the switch Xe1 and a source of the FET formed of the switch Xe2 are connected to each other, a drain of the FET formed of the switch Xe1 is connected to the Ve power source, and a drain of the FET formed of the switch Xe2 is connected to the X electrode.

Although FIG. 3 illustrates the two n-channel FETs that are connected back-to-back and having switches as body diodes, switches connected between the Ve power source and the X electrode and apply the Ve voltage to the X electrode when the switches are turned on that do not have body diodes also can alternatively be used.

The switch Xg has a first end connected to the GND power source that supplies the 0V voltage and a second end connected to the X electrode. In the driving waveform, the voltage of the X electrode is changed to the Ve voltage from the −Vs voltage when the first reset period ends. In this case, although it is not shown in FIG. 2, the voltage of the X electrode can be applied by changing the voltage of the X electrode to the Ve voltage from the 0V voltage after changing the voltage of the X electrode to the 0V voltage from the −Vs voltage. As described, the voltage of the X electrode is periodically fluctuated between the −Vs voltage and the Vs voltage during the sustain period. In this case, a sustain discharge pulse can be applied to the X electrode by changing the voltage of the X electrode to the Vs voltage from the 0V voltage after changing the voltage of the X electrode to the 0V voltage from the −Vs voltage, or changing the voltage of the X electrode to the −Vs voltage from the 0V voltage after changing the voltage of the X electrode to the 0V voltage from the Vs voltage. As described, the switch Xg can be turned on when the voltage of the X electrode is changed from a negative voltage to a positive voltage or changed from a positive voltage to a negative voltage. In addition, the GND power source connected to the switch Xg can be used to efficiently discharge the sustain electrode driver during operation of the plasma display device.

However, the present invention is not limited to the circuit of FIG. 3, and, for example, the switch Xg can be omitted for simplification of the sustain electrode driver 500. In such embodiments, a driving voltage may be stably applied to the X electrode and the sustain electrode driver 500 can experience a stable discharge through the GND power source that is connected to the first and second power recovery units 511 and 522 and the scan electrode driver 400.

A driving operation of a scan electrode driver 400 in a reset period and a driving operation of a sustain electrode driver 500 in the reset period will be described in further detail.

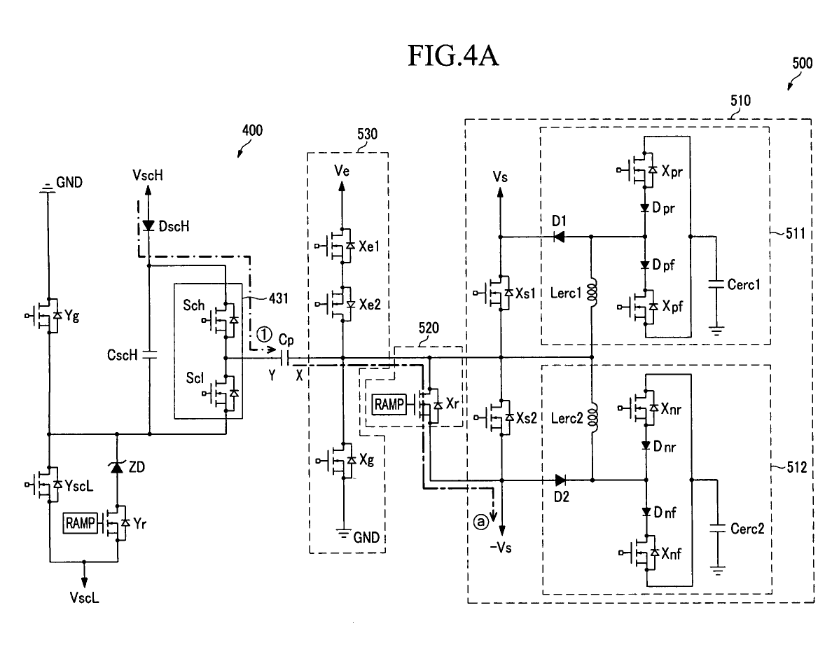

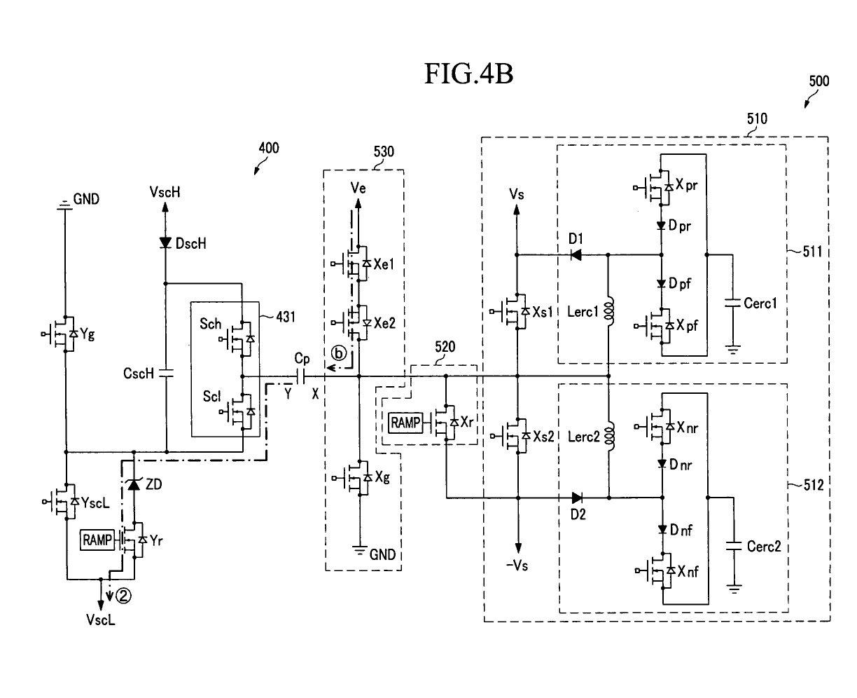

FIG. 4A and FIG. 4B respectively show a current flow in the scan electrode driver 400 of FIG. 3 and the sustain electrode driver 500 of FIG. 3 in the reset period.

Assume that the switch YscL is turned at an initial driving stage of the plasma display device and the capacitor CscH is charged with the dVscH voltage that corresponds to a voltage difference (VscH−VscL) between the VscH voltage and the VscL voltage.

As previously described, the voltage of the X electrode is gradually decreased to the −Vs voltage while the VscH voltage is applied to the Y electrode during the first reset period of the reset period.

In order to generate such a driving waveform, as shown in FIG. 4A, the switch Yg and the switch Sch of the selection circuit 431 in the scan electrode driver 400 are turned on. Then, a current path \textcircled{1} is formed from the GND power source through the switch Yg, the capacitor CscH, and the switch Scl to the Y electrode of the panel capacitor Cp, and the dVscH voltage charged in the capacitor CscH is applied to the Y electrode through the current path \textcircled{1}.

Simultaneously, the switch Xr of the sustain electrode driver 500 is turned on. When the switch Xr is turned on, a current path \textcircled{a} is formed from the X electrode of the panel capacitor Cp through the switch Xr to the −Vs power source as shown in FIG. 4A. In this case, a constant amount of current flows through the current path \textcircled{a} so that the voltage of the X electrode is gradually decreased.

As described, the voltage of the X electrode is decreased to the −Vs voltage by turning on the switch Xr, and a slope with which the voltage of the X electrode decreases is determined by the magnitude of the current flowing through the current path \textcircled{a}.

In addition, during the second reset period, the voltage of the Y electrode is gradually decreased to the Vnf voltage while the Ve voltage is applied to the X electrode.

In order to generate such a driving waveform, the switch Xe1 of the sustain electrode driver 500 is turned on as shown in FIG. 4B. Then, a current path \textcircled{b} is formed from the Ve power source through the body diodes of the switches Xe1 and Xe2 to the X electrode of the panel capacitor Cp, and the Ve voltage is applied to the X electrode through the current path \textcircled{b}.

In addition, the switch Scl of the selection circuit 431 and the switch Yr of the scan electrode driver 400 are turned on. Then, a current path \textcircled{2} is formed from the Y electrode of the panel capacitor Cp through the switch Scl, the Zener diode ZD and the switch Yr to the VscL power source, as shown in FIG. 4B. In this case, the voltage of the Y electrode is gradually decreased to the Vnf voltage that corresponds to a sum of the Vscl voltage and the breakdown voltage of the Zener diode ZD. Herein, a slope by which the voltage of the Y electrode decreases depends on the intensity of the current flowing through the current path \textcircled{2}.

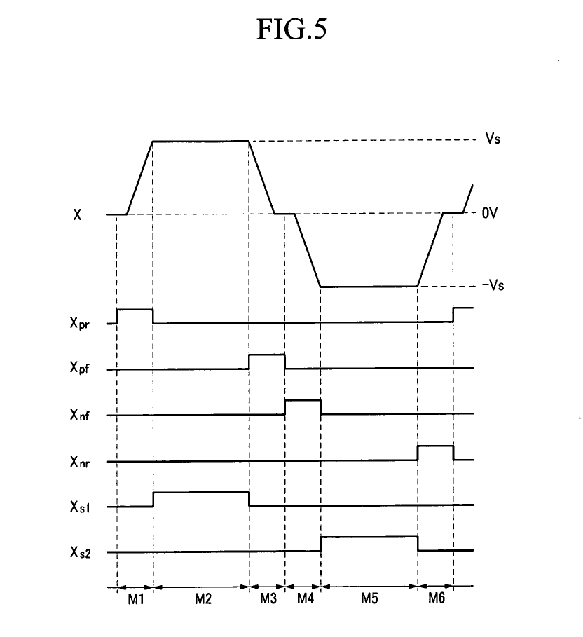

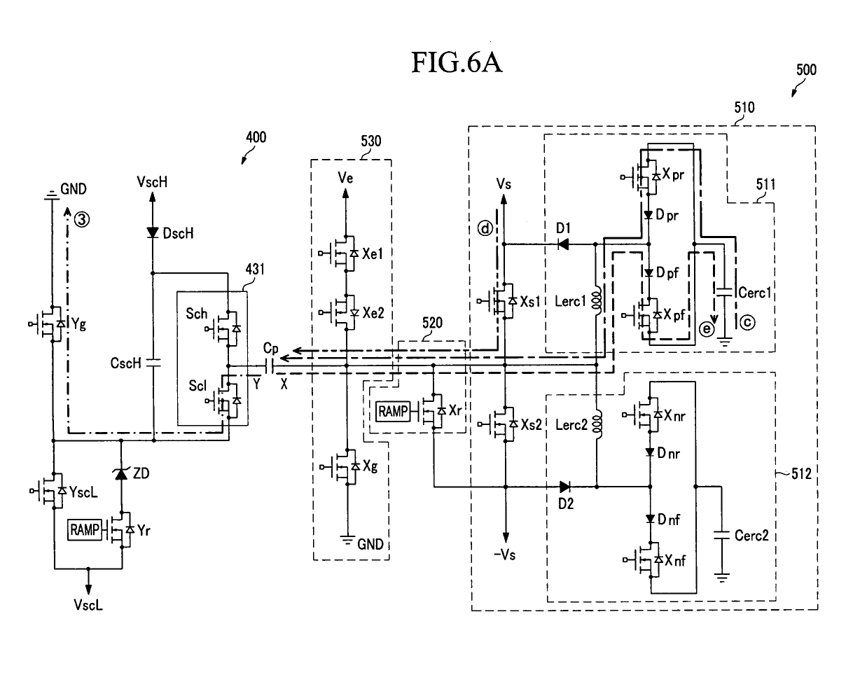

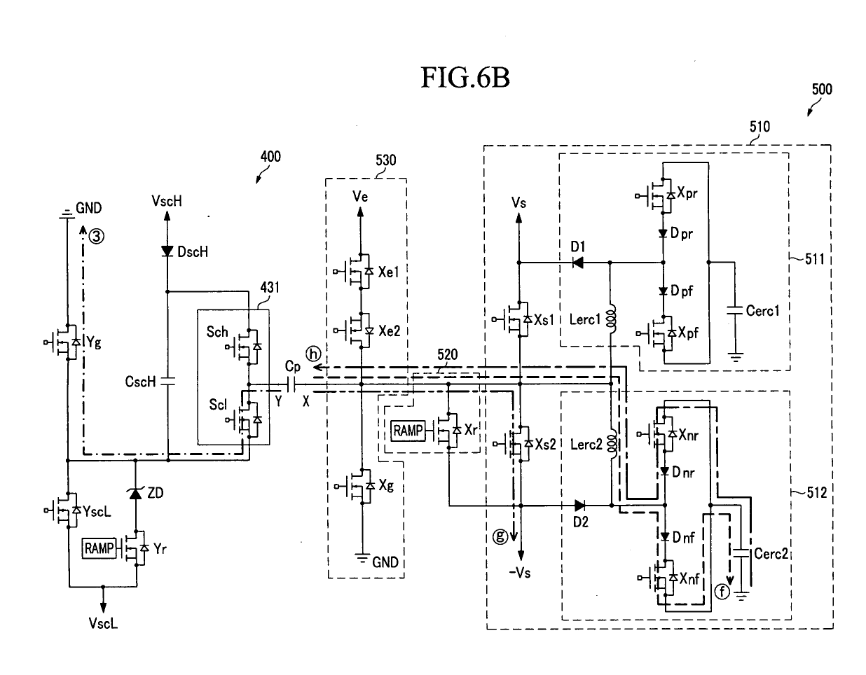

A time-variant operation of the scan electrode driver 400 and the sustain electrode driver 500 in the sustain period a will be described in further detail with reference to FIG. 5, FIG. 6A, and FIG. 6B. The operation is sequentially performed through 6 modes (from M1 to M6) and the mode can be changed from one to another by an operation of one or more switches. In the following description, the term LC resonance is used. It should be understood that the term does not necessarily refer to the infinite behavior of oscillation. In the following description, the term LC resonance is used to specify the curve or pattern according to which the behavior of voltage will follow during an increase or a decrease thereof.

FIG. 5 shows a driving timing during a sustain period in a circuit of the sustain electrode driver 500 of FIG. 3, and FIG. 6A and FIG. 6B show a current flow during the sustain period in the circuit of FIG. 3.

As previously described, a sustain pulse of the −Vs voltage and a sustain pulse of the Vs voltage are alternately applied to the X electrode while the voltage of the Y electrode is maintained at the 0V voltage during the sustain period. That is, the scan electrode driver 400 turns on the switch Yg and the switch Scl of the selection circuit 431 in the sustain period. Then, a current path \textcircled{3} is formed from the GND power source through the switch Yg and the switch Scl of the selection circuit 431 to the Y electrode of the panel capacitor Cp, and the 0V voltage is applied to the Y electrode through the current path \textcircled{3}. Since the Y electrode is maintained at the 0V voltage during the sustain period, this will not be further mentioned in the following description.

Assume that the voltage of the X electrode of the panel capacitor Cp is close to the 0V voltage before the mode 1 M1 is started.

In the mode 1 M1, the switch Xpr is turned on. Then, as shown in FIG. 6A, a current path \textcircled{c} is formed from the capacitor Cerc1 through the switch Xpr, the diode Dpr, and the inductor Lerc1 to the X electrode of the panel capacitor Cp. In this case, an LC resonance is generated between the panel capacitor Cp, the inductor Lerc1, and the capacitor Cerc1. Since the capacitor Cerc1 is charged with a voltage between the 0V voltage and the Vs voltage at this time, the voltage of the X electrode of the panel capacitor Cp is increased close to the Vs voltage by the resonant current flowing through the current path \textcircled{c}.

In the mode 2 M2, the switch Xpr is turned off and the switch Xs1 is turned on. Then, a current path \textcircled{d} is formed from the Vs power source through the switch Xs1 to the X electrode of the panel capacitor Cp, as shown in FIG. 6A. In this case, the Vs voltage is applied to the X electrode through the current path \textcircled{d}.

In the mode 3 M3, the switch Xs1 is turned off and the switch Xpf is turned on. Then, a current path \textcircled{e} is formed from the X electrode of the panel capacitor Cp through the inductor Lerc1, the diode Dpf, and the switch Xpf to the capacitor Cerc1, as shown in FIG. 6A. In the current path \textcircled{e}, a resonant current is generated due to the LC resonance generated between the panel capacitor Cp, the inductor Lerc1, and the capacitor Cerc1, and the voltage charged in the panel capacitor Cp is discharged due to the resonant current so that the voltage of the X electrode of the panel capacitor Cp is decreased close to the 0V voltage.

In the mode 4 M4, the switch Xpf is turned off and the switch Xnf is turned on. Then, a current path \textcircled{f} is formed from the X electrode of the panel capacitor Cp through the inductor Lerc2, the diode Dnf, and the switch Xnf to the capacitor Cerc2, as shown in FIG. 6B. In this case, a resonant current is generated due to the LC resonance generated between the panel capacitor Cp, the inductor Lerc2, and the capacitor Cerc2 in the current path \textcircled{f}, and the voltage of the X electrode of the panel capacitor Cp is decreased close to the −Vs voltage due to the resonant current.

In the mode 5 M5, the switch Xnf is turned off and the switch Xs2 is turned on. Then, a current path \textcircled{g} is formed from the −Vs power source through the switch Xs2 to the X electrode of the panel capacitor Cp, as shown in FIG. 6B. In this case, the −Vs voltage is applied to the X electrode of the panel capacitor Cp through the current path \textcircled{g}.

In the mode 6 M6, the switch Xs2 is turned off and the switch Xnr is turned on. Then, a current path \textcircled{h} is formed from the capacitor Cerc2 through the switch Xnr, the diode Dnr, and the inductor Lerc2 to the X electrode of the panel capacitor Cp, as shown in FIG. 6B. In this case, an LC resonance is generated between the panel capacitor Cp, the inductor Lerc2, and the capacitor Cerc2 by the current path \textcircled{h}. Since the capacitor Cerc2 is charged with a voltage between the −Vs voltage and the 0V voltage, the voltage of the X electrode of the panel capacitor Cp is increased close to the 0V voltage due to the LC resonance in the current path \textcircled{h}.

After the mode 3 M3 ends, the 0V voltage may be applied to the X electrode before the mode 4 M4 is started. That is, the switch Xnf can be turned on after applying the 0V voltage to the X electrode by turning on the switch Xg after turning off the switch Xpf. In addition, after the mode 6 M6 ends, the 0V voltage may be applied to the X electrode before mode 1 M1 is started. That is, the switch Xpr can be turned on after the 0V voltage is applied to the X electrode by turning on the switch Xg after turning off the switch Xnr. In this way, the voltage of the X electrode can be stably fluctuated during the sustain period.

As shown in FIG. 5, FIG. 6A, and FIG. 6B, the Vs voltage and the −Vs voltage can be alternately applied to the X electrode by repeating the mode 1 to the mode 6 M1 to M6 during the sustain period. In addition, when the power recovery unit that is divided into the two power recovery circuits 511 and 512 is used, a power loss equals 1/2Cp(Vs)²+1/2Cp(Vs)², which is less than a power loss in the case that the Vs voltage and the −Vs voltage are alternately applied to the Y electrode. Therefore, the power loss can be reduced more by dividing the power recovery unit into two power recovery units than by alternately applying the Vs voltage and the −Vs voltage to the Y electrode.

In addition, a voltage difference between the X electrode and the Y electrode can be gradually increased without applying a voltage that is greater than the Vs voltage to the Y electrode. Therefore, a plurality of elements included in the scan electrode driver can have lower maximum voltages, thereby improving reliability of the circuit.

In addition, in the scan electrode driver, a body diode provided inside the transistor that forms the switch Yg connected to the GND power source that supplies the 0V voltage has an anode connected to the Y electrode, and a body diode provided inside the transistor that forms the switch YscL connected to the VscL power source that supplies the VscL voltage has a cathode connected to the Y electrode. Consequently, there is no need of providing an additional element between the GND power source and the VscL power source for preventing a negative voltage from being applied to the GND power source, and therefore the scan electrode driver can be more simply designed.

In addition, a sustain discharge pulse of the −Vs voltage and a sustain discharge pulse of the Vs voltage are alternately applied only to the X electrode that is formed of a common electrode while the voltage of the Y electrode is maintained at the 0V voltage during the sustain period. In this way, a distortion between sustain discharge pulses applied to the respective Y electrodes due to application of the sustain discharge pulses through the plurality of selection circuits that are respectively connected to the Y electrodes can be prevented from being generated, and a high voltage applied to the selection circuit can be reduced, thereby improving reliability of the circuit.

In addition, the switches Xpr, Xs 1, Xpf, Xnf, Xs2, and Xnr are sequentially turned on so as to alternately apply the sustain discharge pulse of the Vs voltage and the sustain discharge pulse of the −Vs voltage to the X electrode during the sustain period. In addition, the inductor Lerc1 for recovering power of the sustain discharge pulse of the Vs voltage sustain pulse and the inductor Lerc2 for recovering power of the sustain discharge pulse of the −Vs voltage are separately provided.

Hereinafter, a sustain electrode driver 500 that can stably generate a sustain discharge pulse while reducing the number of elements will be described in further detail. The sustain electrode driver 500 includes a sustain driver 510.

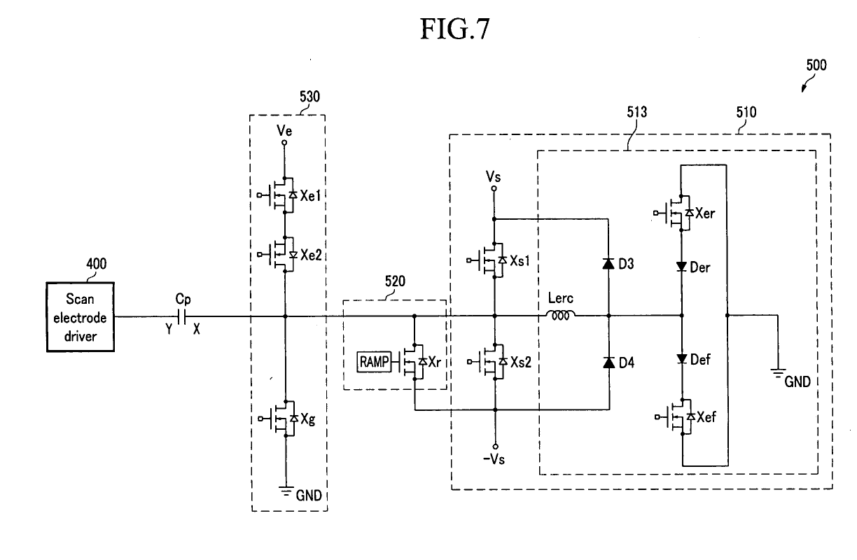

FIG. 7 shows a sustain electrode driver 500 according to another embodiment.

According to the driver of FIG. 7, the sustain driver 510 includes switches Xs1 and Xs2 and a power recovery unit 513.

As shown in FIG. 7, the switch Xs1 has a first end connected to a Vs power source that supplies a Vs voltage and a second end connected to the X electrode, and applies the Vs voltage to the X electrode when it is turned on in a sustain period. The switch Xs2 has a first end connected to a −Vs voltage that supplies a −Vs voltage and a second end connected to the X electrode, and applies the −Vs voltage to the X electrode when it is turned on in the sustain period.

The power recovery unit 513 includes switches Xer and Xef, diodes Der, Def, D3, and D4, and an inductor Lerc.

The switch Xer has a first end connected to a GND power source that supplies 0V voltage and a second end connected to an anode of the diode Der, and a cathode of the diode Der is connected to a first end of the inductor Lerc. In addition, the switch Xef has a first end connected to the GND power source and a second end connected to a cathode of the diode Def, and an anode of the diode Def is connected to the first end of the inductor Lerc. A second end of the inductor Lerc is connected to the X electrode.

The diode D3 has a cathode connected to a Vs power source and an anode connected to the first end of the inductor Lerc, and the diode D3 conducts when a voltage at the first end of the inductor Lerc becomes greater than a Vs voltage due to the inductor Lerc so that the voltage at the first end of the inductor Lerc is clamped to the Vs voltage.

The diode D4 has an anode connected to a −Vs power source and a cathode connected to the first end of the inductor Lerc, and the diode D4 conducts when the voltage at the first end of the inductor Lerc becomes less than a −Vs voltage due to the inductor Lerc so that the voltage at the first end of the inductor Lerc is clamped to the −Vs voltage.

Although it is not shown, positions of the switch Xer and the diode Der can be switched with each other and positions of the switch Xef and the diode Def can also be switched with each other in the power recovery unit 513. That is, the cathode of the diode Der may be connected to the first end of the switch Xer and the first end of the inductor Lerc may be connected to the switch Xer. In addition, the anode of the diode Def may be connected to the first end of the switch Xef and the first end of the inductor Lerc may be connected to the second end of the switch Xef.

A driving operation of the sustain electrode driver 500 in the sustain period will now be described in further detail.

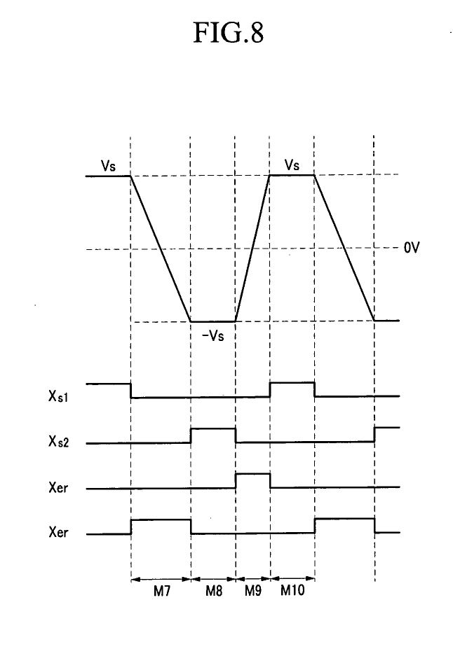

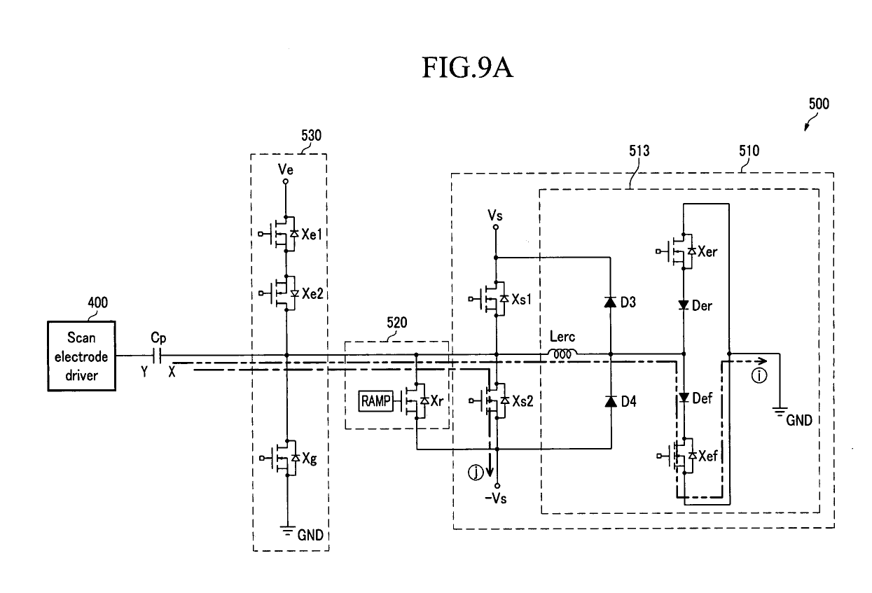

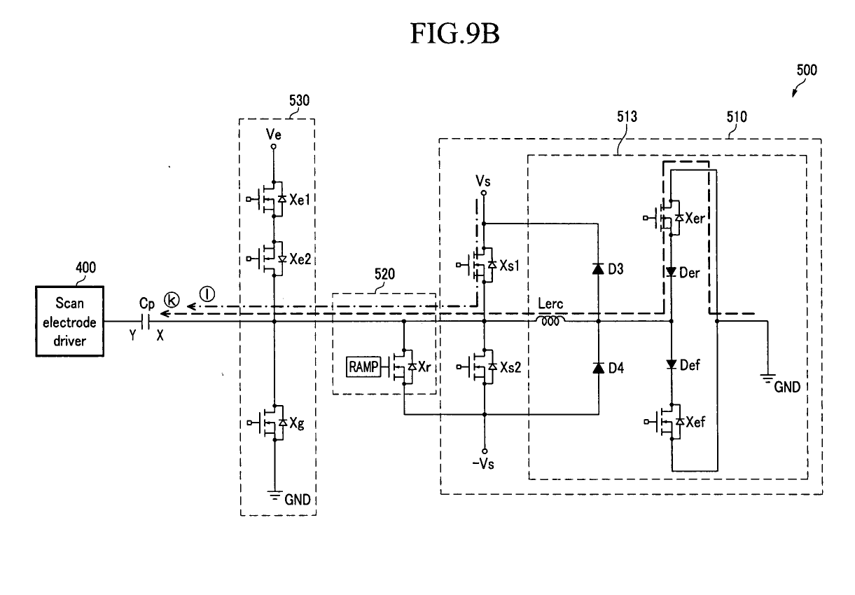

FIG. 8 shows a driving time of the sustain electrode driver 500 of FIG. 7 in the sustain period, and FIG. 9A and FIG. 9B show current flows of the sustain electrode driver 500 of FIG. 7 during the sustain period.

During the sustain period, the scan electrode driver 400 turns on the switch Yg and the switch Scl of the selection circuit 431 and applies the 0V voltage to the Y electrode through a current path formed from the GND power source through the switch Yg, and the switch Scl of the selection circuit 431 to the Y electrode of the panel capacitor Cp. Since the voltage of the Y electrode is maintained at the 0V voltage during the sustain period, this will not be further described.

In the following description of the driving operation of the sustain electrode driver in the sustain period, it is assumed that the voltage of the X electrode equals the Vs voltage before a mode M7 is started. The driving operation is sequentially performed through 4 modes m7 to M10, and the mode can be changed from one to another by an operation of one or more switches. In the following description, the term LC resonance is used. It should be understood that the term does not necessarily refer to the infinite behavior of oscillation. In the following description, the term LC resonance is used to specify the curve or pattern according to which the behavior of voltage will follow during an increase or a decrease thereof.

In the mode 7 M7, the switch Xef is turned on, and a current path \textcircled{i} is formed from the X electrode of the panel capacitor Cp through the inductor Lerc, the diode Def, and the switch Xef to the GND power source, as shown in FIG. 9A. In this case, an LC resonance is generated between the panel capacitor Cp and the inductor Lerc so that the voltage of the X electrode is decreased close to the −Vs voltage due to a resonant current flowing through the current path \textcircled{i}.

In the mode 8 M8, the switch Xs2 is turned on, and a current \textcircled{j} is formed from the X electrode of the path panel capacitor Cp through the switch Xs2 to the −Vs power source, as shown in FIG. 9A. In this case, the voltage of the X electrode is maintained at the −Vs voltage due to the current flowing through the current path \textcircled{j}.

In the mode 9 M9, the switch Xer is turned on, and a current path \textcircled{k} is formed from the GND power source through the switch Xer through the diode Der to the X electrode of the panel capacitor Cp, as shown in FIG. 9B. In this case, an LC resonance is generated between the panel capacitor Cp and the inductor Lerc so that the voltage of the X electrode is increased close to the Vs voltage due to a resonant current flowing to the current path \textcircled{k}.

In the mode 10 M10, the switch Xs1 is turned on and a current path \textcircled{i} is formed from the Vs power source through the switch Xs1 to the X electrode of the panel capacitor Cp, as shown in FIG. 9B. In this case, the voltage of the X electrode is maintained at the Vs voltage due to the current flowing through the current path \textcircled{i}.

As described above, a circuit can be simply designed and the number of changes in switching operation can be reduced so that the amount of heat generation can be reduced, thereby stably and efficiently driving the circuit.

The VscL voltage sequentially applied to the Y electrodes during the address period may be set to have the same voltage level as the −Vs voltage applied to the X electrode during the sustain period.

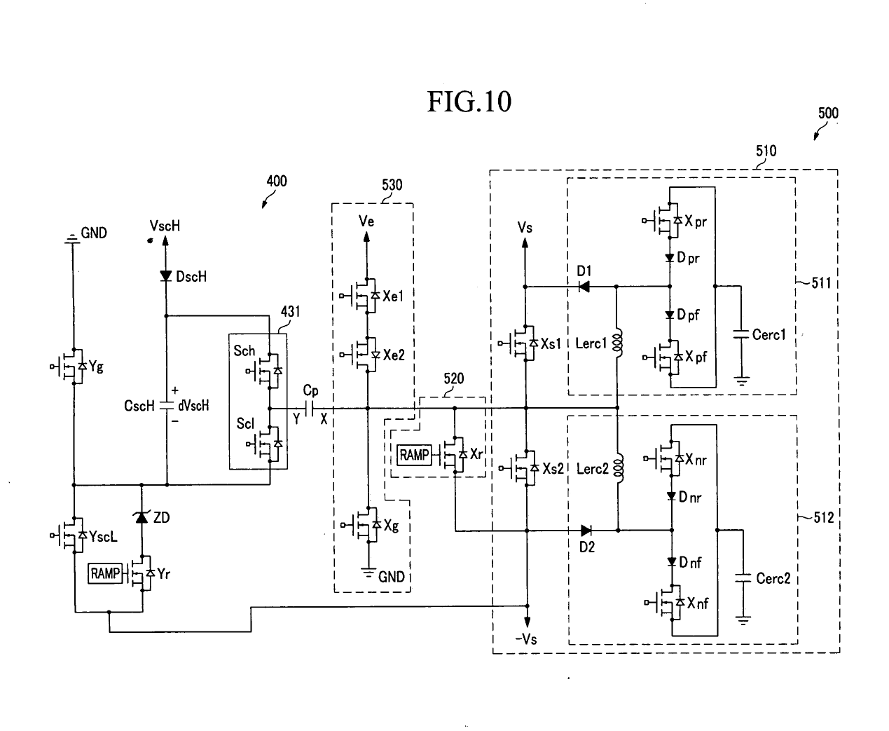

FIG. 10 shows a scan electrode driver 400 and a sustain electrode driver 500 according to an embodiment.

As shown in FIG. 10, the scan electrode driver 400 and the sustain electrode driver 500 acc are the same as those of FIG. 3, except that the VscL power in the scan electrode driver 400 is omitted and the −Vs power source is used as a power source that supplies the VscL voltage.

The scan electrode driver 400 of FIG. 10 uses the −Vs power source as a power source that supplies the VscL voltage, and therefore a scan voltage sequentially applied to the Y electrodes during the address period corresponds to the −Vs voltage. In addition, the voltage of the Y electrode is gradually decreased from the 0V voltage to the Vnf voltage during the second reset period, and in this case, the Vnf voltage corresponds to a sum of the −Vs voltage and the breakdown voltage of the Zener diode ZD.

As described, the number of power sources can be reduced since the VscL power source can be omitted such that the circuit can be simply designed.

According to the presented embodiments, a driving waveform for generating a sustain discharge during a sustain period can be prevented from being distorted. In addition, a maximum voltage applied to a scan electrode driver can be reduced and the scan electrode driver can be simply designed, thereby improving reliability of the circuit.

While this invention has been described in connection with what is presently considered to be practical embodiments, it is to be understood that the invention is not limited to the disclosed embodiments, but, on the contrary, is intended to cover various modifications and equivalent arrangements.

What is claimed is:

1. A plasma display device comprising:
a plasma display panel (PDP) having a plurality of first electrodes and a plurality of second electrodes;
a first driver connected to the plurality of first electrodes and configured to apply a first voltage to the plurality of first electrodes during a sustain period; and
a second driver connected to the plurality of second electrodes and configured to apply a sustain discharge pulse to the plurality of second electrodes during the sustain period, the sustain discharge pulse alternately having a second voltage that is greater than the first voltage and a third voltage that is less than the first voltage,
wherein the first driver comprises:
a first switch having a first end connected to a first power source that supplies the first voltage, a second end connected to the plurality of first electrodes, and a body diode having a cathode connected to the first end of the first switch and an anode connected to the second end of the first switch, and
a second switch having a first end connected to a second power source that supplies a fourth voltage that is less than the first voltage, a second end connected to the plurality of first electrodes, and a body diode having an anode connected to the first end of the second switch and a cathode connected to the second end of the second switch, wherein
the second end of the first switch and the second end of the second switch are connected to each other.

2. The plasma display device of claim 1, wherein the second driver comprises a third switch having a first end connected to a third power source that supplies the third voltage and a second end connected to the plurality of second electrodes, the second driver configured to turn on the third switch during a portion of a reset period and gradually change a voltage of the plurality of second electrodes to the third voltage.

3. The plasma display device of claim 2, wherein the second driver comprises:
a fourth switch having a first end connected to a fourth power source that supplies the second voltage and a second end connected to the plurality of second electrodes; and
a fifth switch having a first end connected to the third power source and a second end connected to the plurality of second electrodes.

4. The plasma display device of claim 3, wherein the second driver further comprises a power recovery unit that recovers reactive power of a panel capacitor, comprising the first electrodes and the second electrodes,
wherein the power recovery unit comprises:
an inductor having a first end connected to the plurality of second electrodes;
a sixth switch having a first end connected to the first power source and a second end connected to a second end of the inductor; and
a seventh switch having a first end connected to the second end of the inductor and a second end connected to the first power source.

5. The plasma display device of claim 4, wherein the power recovery unit further comprises:
a first diode having an anode connected to the second end of the sixth switch and a cathode connected to the second end of the inductor;
a second diode having a cathode connected to the first end of the seventh switch and an anode connected to the second end of the inductor;
a third diode having a cathode connected to the fourth power source and an anode connected to the second end of the inductor; and
a fourth diode having an anode connected to the third power source and a cathode connected to the second end of the inductor.

6. The plasma display device of claim 3, wherein the second driver comprises:
a first power recovery unit including a fifth power source charged with a voltage between the first voltage and the second voltage and a first inductor connected between the fifth power source and the plurality of second electrodes; and
a second power recovery unit including a sixth power source charged with a voltage between the first voltage and the third voltage and a second inductor connected between the sixth power source and the plurality of second electrodes.

7. The plasma display device of claim 6, wherein the fifth and sixth power sources comprise capacitors.

8. The plasma display device of claim 6, wherein:
the first power recovery unit further comprises a sixth switch having a first end connected to the first end of the fifth power source and a second end connected to the first end of the first inductor, and a seventh switch having a first end connected to the first end of the fifth power source and a second end connected to the first end of the first inductor;
the second power recovery unit further comprises an eighth switch having a first end connected to the first end of the sixth power source and a second end connected to the first end of the second inductor, and a ninth switch having a first end connected to the first end of the sixth power source and the first end of the second inductor; and
the second end of the first inductor and the second end of the second inductor are connected to the plurality of second electrodes.

9. The plasma display device of claim 8, wherein:
the first power recovery unit further comprises a first diode having an anode connected to the first end of the fifth power source and a cathode connected to the first end of the first inductor, and a second diode having a cathode connected to the first end of the fifth power source and an anode connected to the first end of the first inductor; and
the second power recovery unit further comprises a third diode having an anode connected to the first end of the sixth power source and a cathode connected to the first end of the second inductor, and a fourth diode having a cathode connected to the first end of the sixth power source and an anode connected to the first end of the second inductor.

10. The plasma display device of claim 9, wherein:
the first power recovery unit further comprises a fifth diode having a cathode connected to the fourth power source and an anode connected to the first end of the first inductor; and
the second power recovery unit further comprises a sixth diode having an anode connected to the third power source and a cathode connected to the first end of the second inductor.

11. The plasma display device of claim 3, wherein the first driver comprises:
a plurality of selection circuits respectively connected to the plurality of first electrodes configured to selectively apply a voltage of a first node or a second node to a selected first electrode among the plurality of first electrodes; and
a capacitor having a first end connected to a fifth power source that supplies a fifth voltage and a second end connected to the second end of the second switch, the capacitor configured to be charged with a sixth voltage that corresponds to a voltage difference between the voltage of the fifth power source and the voltage of the fourth power source.

12. The plasma display device of claim 11, wherein the first driver further comprises:
a diode having a cathode connected to the plurality of first electrodes; and
a sixth switch having a first end connected to an anode of the diode and a second end connected to the second power source, is the sixth switch being configured to be turned on during a portion of the reset period and to gradually change a voltage of the first electrodes to a seventh voltage that is greater than the fourth voltage.

13. The plasma display device of claim 12, wherein the seventh voltage corresponds to a sum of the second voltage, and a breakdown voltage of the diode.

14. The plasma display device of claim 3, wherein the plurality of second electrodes are collectively applied with the same driving waveform.

15. The plasma display device of claim 3, wherein the third voltage and the fourth voltage are substantially equal.

16. The plasma display device of claim 3, wherein the second voltage and the third voltage have substantially equal magnitude and are of opposite polarity with respect to the first voltage.

17. A driving method of a plasma display device having a plurality of first electrodes and a plurality of second electrodes, the driving method comprising:
during a sustain period, maintaining the voltage of the first electrodes at a first voltage by turning on a first switch connected between a first power source that supplies the first voltage and the plurality of first electrodes, and alternately applying a sustain discharge pulse to the plurality of second electrodes, the sustain discharge pulse having a second voltage and a third voltage, the second voltage being greater than a first voltage and the third voltage being less than the first voltage;
during a reset period, gradually decreasing a voltage of the plurality of second electrodes to the second voltage while maintaining the voltage of the plurality of first electrodes at a fourth voltage, the fourth voltage being greater than the first voltage, and gradually decreasing the voltage of the plurality of first electrodes to a sixth voltage, the sixth voltage being less than the first voltage, and maintaining a voltage of the plurality of second electrodes at a fifth voltage, the fifth voltage greater than the first voltage; and
during an address period, sequentially applying a seventh voltage to the plurality of first electrodes by turning on a second switch connected between a second power source that supplies the seventh voltage, the seventh voltage being less than the first voltage.

18. The driving method of claim 17, wherein the first switch and the second switch respectively comprise body diodes having anodes connected to first ends of the first and second switches and cathodes connected to second ends of the first and second switches, wherein the first end of the first switch and the second end of the second switch are connected to each other.

19. The driving method of claim 17, wherein, during the reset period, the voltage of the plurality of second electrodes is gradually decreased by turning on a third switch connected between a third power source that supplies the third voltage and the plurality of second electrodes.

20. The driving method of claim 17, wherein voltage levels of the seventh voltage and the third voltage have the same absolute value.
